(19) United States
(12) Patent Application Publication
(10) Pub. No.: US 2019/0320602 A1
(43) Pub. Date: Oct. 24, 2019

(54) LOW POWER DATA TRANSMISSION FOR SPRINKLER SYSTEMS

(71) Applicant: Rachio, Inc., Denver, CO (US)

(72) Inventor: Adam DOEHLING, Arvada, CO (US)

(21) Appl. No.: 16/390,221

(22) Filed: Apr. 22, 2019

Related U.S. Application Data
(60) Provisional application No. 62/661,369, filed on Apr. 23, 2018.

(51) Int. Cl. A01G 25/16; H04W 52/02; A01G 27/00; H04L 29/08

(52) U.S. Cl. CPC A01G 25/167; H04L 67/125; A01G 27/003; H04W 52/0229

(57) ABSTRACT

A system may include a sprinkler or irrigation controller and one or more sensor devices. The controller may receive sensor data from the sensor devices and, based on the sensor data, controls operation of the system. The sensor devices may sleep until awoken by the controller. The controller requests data from a sensor device by sending a sequence of wake up messages to the sensor device followed by a message payload. Upon receiving a wake up message, the sensor device determines the time when the message payload from the controller will be received, and sleep again until that time. Then, the sensor wakes and receives the message payload transmitted to the sensor device at the determined time. Rather than waking up for the entire duration of waiting for the message payload, sleeping between the wake up message and the message payload allows the sensor device to reduce power consumption.

### CROSS REFERENCE

This application claims the benefit of priority under 35 U.S.C. § 119 to U.S. Provisional Application No. 62/661,369 entitled “System and Method for Transmitting Data Between Devices,” the disclosure of which is incorporated herein by reference in its entirety.

### FIELD

The present disclosure relates generally to transmitting data between devices and in particular to transmitting sensor data between a controller and a node device.

### BACKGROUND

Sprinkler systems may include auxiliary sensors, such as precipitation sensors, that detect characteristics to vary a preset watering schedule, e.g., a planned watering event will be cancelled if the precipitation sensor detects that it has recently rained. However, many of these types of auxiliary sensors or other types of auxiliary devices may be located in the area to be watered, e.g., a user's backyard, and rely on batteries to provide power. Conventional data communication techniques for auxiliary sensors or other auxiliary devices require the devices to remain awake during long intervals, which can quickly drain the batteries.

For example, with a node device communicating data to a central device or controller, the node device will periodically listen for communication from the controller at a fixed interval. At the end of each fixed interval, the node device wakes up and checks for messages from the controller. If the fixed interval is too long, a node device may not timely receive a message from the controller or respond to the controller. If the fixed interval is too short, the node device will constantly wake up and check messages, requiring significant power consumption. This type of increased power consumption required in more sensitive and accurate systems can be problematic with battery powered devices.

### SUMMARY

In one embodiment, an irrigation system is disclosed. The irrigation system includes a sensor device configured to detect irrigation characteristics indicating one or more irrigation conditions and a controller in electrical communication with the sensor device and with one or more irrigation values to activate the irrigation valves according to an irrigation schedule. The controller transmits a first plurality of wake messages in sequence to the sensor device and subsequent to transmitting the plurality of wake message in sequence, transmits a message payload packet to the sensor device. The sensor device sleeps for a duration of a wait time interval after receiving one of the plurality of wake messages in the wakeup sequence and before receiving the payload packet.

In another embodiment, a sensor device for use in a sprinkler system is disclosed. The sensor includes a network interface in electrical communication with a controller, a sensor configured to capture sensor data, and a processing element in electrical communication with the sensor and the network interface. The processing element receives one of a plurality of wake messages from the controller, where the plurality of wake message are transmitted in sequence, determines a wait time interval, sleeps for a duration of the wait time interval, and wakes to receive a message payload packet from the controller.

In yet another embodiment, a method for transmitting data within a sprinkler system is disclosed. The method includes transmitting a plurality of wake messages in sequence to at least one node device in the communication system, subsequent to transmitting the plurality of wake messages in sequence, transmitting a message payload packet to the node device, and receiving a response packet from the node device responsive to the message payload packet. By the node device, receiving one of the plurality of wake messages from the sprinkler controller, determining a wait time interval, sleeping for a duration of the wait time interval, waking up to receive a message payload packet from the sprinkler controller, and transmitting a response packet to the controller responsive to the message payload packet.

### BRIEF DESCRIPTION OF THE DRAWINGS

FIG. 1 is a block diagram illustrating an example of an irrigation system according to various aspects of the present disclosure.

FIG. 2 is a diagram of communications between a controller and a sensor device in the system of FIG. 1 according to various aspects of the present disclosure.

FIG. 3A illustrates an example of packet communication between a controller and a node device according to various aspects of the present disclosure.

FIG. 3B illustrates an example of a message payload packet transmitted from the controller to a node device and a device response packet transmitted from the node device to the controller according to various aspects of the present disclosure.

FIG. 4 illustrates an example of a wake message format.

FIG. 5A is a flow chart illustrating a method for a controller to communicate with one or more node devices.

FIG. 5B is a flow chart illustrating a method for a receiver node device to communicate with a controller.

FIG. 6 is a simplified block diagram of a computing device that can be used by one or more components of the system of FIG. 1.

### SPECIFICATION

Various embodiments of the present disclosure will be explained below in detail with reference to the accompanying drawings. The following detailed description refers to the accompanying drawings that show, by way of illustration, specific aspects and embodiments in which the present invention may be practiced. These embodiments are described in sufficient detail to enable those skilled in the art to practice the present invention. Other embodiments may be utilized, and structure, logical and electrical changes may be made without departing from the scope of the present invention. The various embodiments disclosed herein are not necessary mutually exclusive, as some disclosed embodiments can be combined with one or more other disclosed embodiments to form new embodiments.

In some embodiments, an irrigation system having a controller and one or more sensor or other auxiliary devices that electrically communicate with the controller or other central hub is disclosed. The auxiliary device may be one or more sensors that detect data indicating one or more irrigation characteristics or environmental characteristics, e.g., precipitation received, soil moisture, system or sprinkler flow rates or other flow characteristics, etc. The controller receives the sensor data from the auxiliary devices and, based on the sensor data, varies or otherwise updates the operation of the irrigation system and/or transmits the data to a central controller (e.g., cloud based server structure), which then may modify one or more preset irrigation schedules. For example, when the precipitation sensor or the soil moisture sensor have data values over a particular threshold, the central controller may determine that the next watering event can be skipped since the landscape area has sufficient water. As another example, during a particular hot time, the soil moisture sensor may indicate that the soil is too try and the health of the vegetation may be deteriorating, and the controller may then activate a non-planned watering event. As yet another example, a flow sensor may detect that a sprinkler head is leaking or delivering too much water and the controller may adjust the watering schedules accordingly.

Often, the auxiliary devices are battery operated and located across the irrigated property, e.g., in a particular irrigation zone or the like. As such, battery life is important to conserve, since the sensors can be spread across large distances and/or in difficult to access areas. Alternatively, the devices may include a wired power supply, but rely on wireless transmission of data to and from the controller.

With the present disclosure, the sensor device sleeps or is in a low power mode until awoken by the controller and then receives or transmits data after it awake. For example, the controller requests data from a sensor device by sending a wake up message to the device, the wake message includes a message time or a wakeup time for receiving the request. Upon receiving the wake message, the sensor device determines the time when the request from the controller will be received, and sleeps again until the designated time. At the selected request time, the sensor wakes and receives the request transmitted to the sensor device at the selected time. With this method, rather than remaining awake (e.g., in a higher power state than in a sleep mode) for the entire duration of waiting for the request, the device can sleep or otherwise return to a low power mode between receiving the wake up message and the request, allowing the sensor device to conserve power. Conventional data transmission techniques typically require that the transmitting device remain awake from a time between receiving a wake signal and when the device is to receive a payload packet and/or send data, which can quickly drain the battery of a low powered sensor device.

In a non-limiting example, a precipitation sensor may be powered by a battery and functions to detect or otherwise collect precipitation data (e.g., a rain gauge or other type of collection tool). The precipitation sensor sleeps most of the time to preserve battery. A controller may obtain the precipitation data by sending one or more wake up messages to the precipitation sensor. The wake up messages includes a wake counter. When the precipitation sensor receives a wake up message, the precipitation sensor may use the wake counter in the wake up message to determine a wait time interval, for example, 0.5 seconds, and sleep for the duration of the wait time interval. At about the expiration of the wait time interval, the controller sends a request to the precipitation sensor, and the precipitation sensor wakes at the designated time to be able to receive the request from the controller. Subsequently, the precipitation sensor may process the request from the controller and respond to the controller accordingly (e.g., transmit any data packets back to the controller).

In some embodiments, the controller may send multiple sequences of wake up messages, the sequences including multiple short wake up messages. The shorter preamble and wakeup messages, shortens the window that the sensor needs to be awake to fully receive the full message. However, due to the shortened length, the controller may send multiple sequences to ensure that the sensor will be on during the transmission of at least one of the messages to receive the shorter message. Conventional transmission methods use a long preamble to ensure that the devices receive the information, but such long preambles also mean that the device must remain on for longer in order to ensure that it receives the fully packet, draining battery life. In one embodiment, the sequence and transmission intervals for the wake messages may be selected to ensure that the preamble or wake message is received within two interval checks by the sensor, but selecting the timing such preamble length and transmission times will overlap at least once with the receive preamble checks by the node or sensor device.

In some scenarios, the controller and the sensor devices may communicate over a separate frequency channel in a communication network, helping to prevent a sensor device from unnecessarily waking up for messages meant to be received by other sensor devices or from other forms of noise on the channel Reducing the chance of noise and mistaken wakeups, further helps to reduce battery life. In some embodiments, the wake messages may also be tied to specific auxiliary devices to prevent other devices from inadvertently waking or needing to wake every time a wake message is transmitted from the controller. In this example, the wake message may include a link identifier that is unique for the controller and the specific device, such that the wake message will be specific to a particular device. These embodiments may be helpful when multiple sensors or auxiliary devices are utilizing the same channel to communicate with the controller.

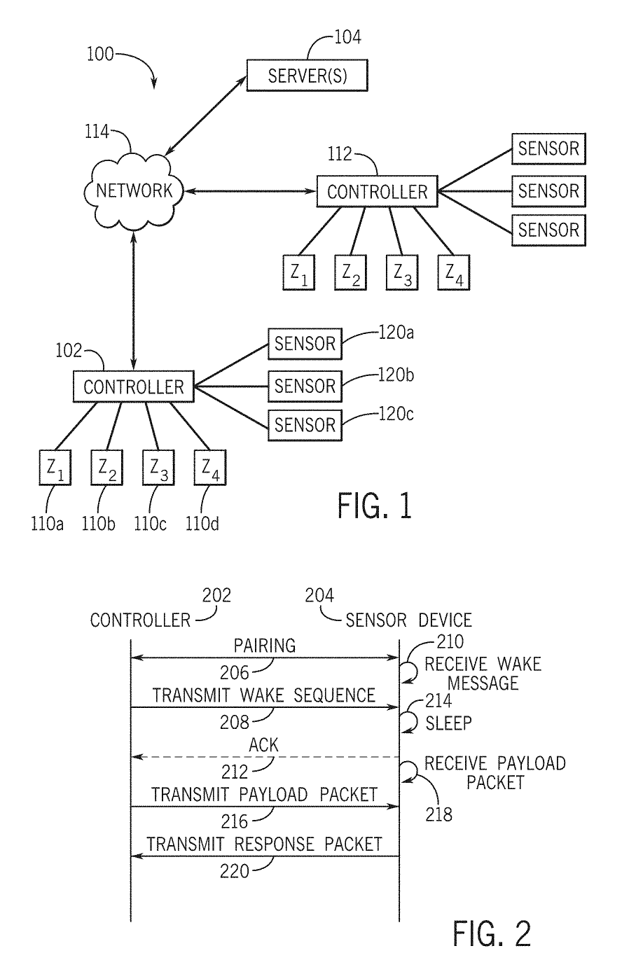

Turning now to the figures, a system of the present disclosure will be discussed in more detail. FIG. 1 is a block diagram illustrating an example of a system 100 that includes a controller 102 in electrical communication with one or more node devices 120a-120c. The controller 102 may be communicating with the node devices 120a-120c via any suitable communication protocols, wired or wirelessly. Controller 102 may be an irrigation system controller, such as a sprinkler controller, or may be another type of hub for receiving and transmitting information from auxiliary devices. System 100 may include one or more additional irrigation system controllers 112. The controllers 102, 112 may control one or more fluid delivery devices, e.g., sprinkler valves, irrigation drip lines, and the like, for one or more irrigation zones 110a, 110b, 110c, 110d. For example, the controller may be in electrical communication with solenoid valves or other electrical valves that cause a sprinkler head or other water output device to open and dispense water across an area. The irrigation controllers 102, 112 are in electrical communication with one or more servers 104 via a network 114. The various components of the watering system 100 may be in communication directly or indirectly with one another, such as through the network 114. In this manner, the components can transmit and receive data from other components in the system. In many instances, the server 104 may act as a go between for some of the components in the system 100.

The network 114 may be substantially any type or combination of types of communication system for transmitting data either through wired or wireless mechanism (e.g., WiFi, Ethernet, Bluetooth, cellular data, or the like). In some embodiments, certain components in the watering system 100 may communicate via a first mode (e.g., Bluetooth, Zigby) and others may communicate via a second mode (e.g., WiFi). Additionally, certain components may have multiple transmission mechanisms and be configured to communicate data in two or more manners. The configuration of the network 114 and communication mechanisms for each of the components may be varied as desired and based on the needs of a particular configuration or property.

The irrigation system controllers 102, 112, nodes, and/or the server(s) 104 may include one or more components such as those shown in FIG. 7. Server 104 may be a central controller. Server 104 may have one or more computing devices that process and execute information. Server 104 may include its own processing elements, memory components, and the like, and/or may be in communication with one or more external components (e.g., separate memory storage) (an example of computing elements that may be included in server 104 is disclosed below with respect to FIG. 7). Server 104 may also include one or more server computers interconnected together via the network 114 or separate communication protocol. Server 104 may host and execute a number of the processes executed by the system 100 and/or the irrigation system controllers 102, 112.

The nodes 120a-120c are auxiliary devices that are in communication with the controller. The nodes 120a-120c may be sensors or other devices that detect or otherwise measure select characteristics that may be used to alter watering schedules or provide feedback to the controller. By way of example, the sensor device 120a-120c may be a precipitation sensor or substantially any type of device that can detect precipitation and/or fluid levels and transmit an electrical signal. In another example, the sensor device may be a soil moisture level detector, such as a soil sensor that measures the soil conditions, water valves (e.g., wireless sprinkler valves), an optical sensor that measures the ambient light or the light or heat intensity at a particular area, or a flow sensor that measures the water flow in the irrigation system. Other examples of node devices include cameras that capture images of the area to be watered (e.g., sprinkler zone areas), soil nutrient detectors, or the like.

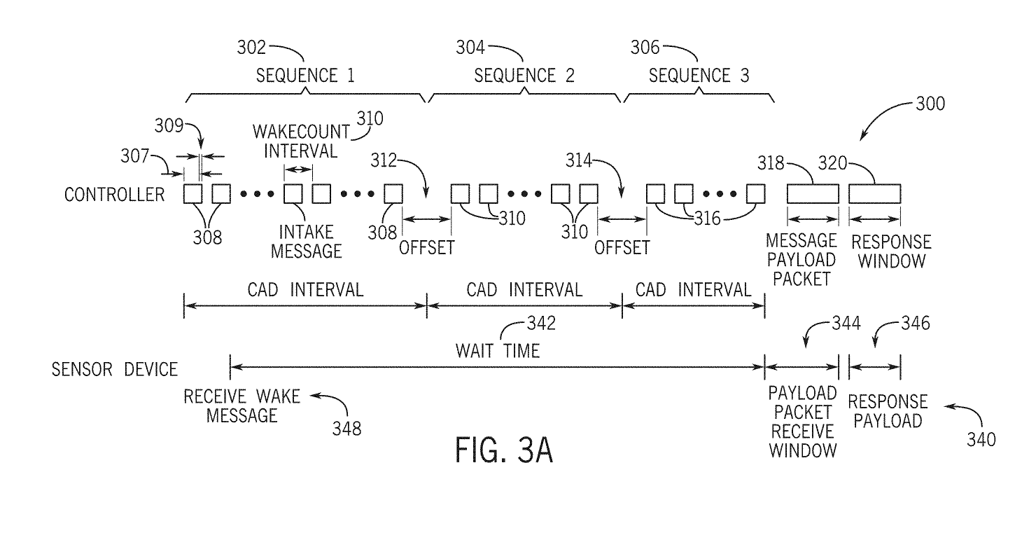

The nodes transmit signals or data to the network 114 and/or controller 102 via hardwired or wireless methods (e.g., WiFi, radio signals, Bluetooth, etc.). The nodes or sensor devices include a receiver to receive electronic data communications and a transmitter to transmit electronic data communications. The receiver/transmitter may be integrated into a single component or be two separate components. The nodes may also include processing elements, such as microprocessors, to assist in collecting data and activating the transmitter/receiver according to the communication protocols described here. The communications between the controller 102, 112 and the associated sensor devices 120a-120c will be further described in detail with reference to FIGS. 2-4.

In FIG. 2, a communication link between the controller 202 and the sensor device 204 or other node device may be established through pairing 206. In some instances, the communication between the controller and the sensor device may utilize unlicensed FCC bands, such as the industrial, scientific, and medical radio (ISM) band. Other radio frequencies may be used. In some scenarios, Semtech radios supporting LoRa modulation may be used to provide long range, low power radio communication.

In pairing with controller 202, sensor device 204 may send a pairing request to the controller. Upon receiving the request, the controller may fetch the sensor device's device specific information (including information, such as address and secure key) from a local memory. Alternatively, and/or additionally, the controller may also fetch a node's device information from the server(s) (104 in FIG. 1) from the communication network (114 in FIG. 1), such as the Internet and/or the cloud. The controller may fetch node's device information by using device dependent information, such as the serial number, to interrogate a database co-located with the server or residing in the cloud. Security measures, such as encryption scheme, may also be used in retrieving device information.

Upon retrieving the device information of sensor device 204, and/or verifying requesting sensor device 204, controller 202 may pair with the sensor device. In pairing with the sensor device, the controller may respond with a radio configuration that will be used for further communication with the sensor device. The radio configuration may specify a number of parameters for communication, e.g., channel selection. In some scenarios, the controller may receive a pairing request from a sensor device, determine a communication channel in the communication network, and establish a communication link with the sensor device on that communication channel. If two sensor devices are communicating with the controller on the same channel, one sensor device may wake up only to receive a message that is sent to the other sensor device on the same channel In some scenarios, the controller may assign a unique channel (e.g., at a unique radio frequency) for the sensor devices. This will allow a sensor device to receive from a controller requests that are sent only to that sensor device, and avoid waking up unnecessarily. In this example, the various nodes may have separate channels that are used to communicate with the controller, such that the nodes will receive wake messages that are applicable only to themselves, rather than having to wake to receive multiple wake messages for multiple auxiliary devices on the same channel In this manner, the nodes may save power because they will not accidentally wake to receive messages not intended for themselves.

Alternatively, and/or additionally, the controller may retrieve a channel number or channel information from the server on the cloud (e.g., 104 in FIG. 1) for use with sensor communication. In a non-limiting example, the controller may transmit the sensor device's device information to the server, the server determines the communication channel, and the controller retrieves the channel selection from the server. In determining the channel selection, the server may monitor one or more communication channels on the communication network and return a channel that is available, or additional information to assist in channel selection, such as link quality or error counts. In other scenarios, the server may determine the channel based on the proximity and/or location of the sensor device to the controller, the number of sensor devices in communication with the controller, information about the additional controllers (e.g., 112 in FIG. 1) and associated sensor devices thereof, link quality, transmission error counts, other information, or a combination thereof.

With further reference to FIG. 2, once sensor device 204 is paired with controller 202, the sensor device 104 may sleep to preserve battery. In other words, the sensor device 104 may transition to a low power mode that conserves energy and “sleeps” most of the active/power consuming features. During operation and as the sensor device collects information, the controller may from time to time request data from the sensor device or node. In these instances, the controller 202 may transmit a wake sequence 208 or wake preamble to wake up sensor device 204. A wake sequence may include multiple wake messages that are repeated over a desired time window to ensure that the sensor, which checks for wake messages intermittently, will receive the wake message. In particular, the sensor device 204 may periodically check for wake up messages from the controller at a channel activity detect (CAD) interval, while sleeping the rest of the time, allowing the device to preserve battery power. In other words, at a predetermined interval, the CAD interval, which may be a period of time selected based on the type of sensor and the number of devices on the channel, the sensor will wake to check for a wake message from the controller. To check for a wake message, the sensor will scan the radio wave communication channel to detect energy.

Upon receiving a wake message 210 in the wake sequence at a CAD interval, rather than actively checking future requests and data transmitted from the controller, sensor device 204 may sleep for a duration of wait time interval 214 before controller 202 is ready to transmit a message payload packet 216 (following the wake message). The sensor device may determine the wait time interval based on information received from the controller, as described in more detail below. Additionally, sensor device 204 may respond with an acknowledgement 212 to controller 202 upon receiving the wake message. In other words, the wake message may include information to the sensor regarding future data to be transmitted from the controller to the sensor, including a time interval at which the sensor can be expected to receive the data. In this manner, the sensor can return to a low powered state since the time interval of the next data transmission will be known.

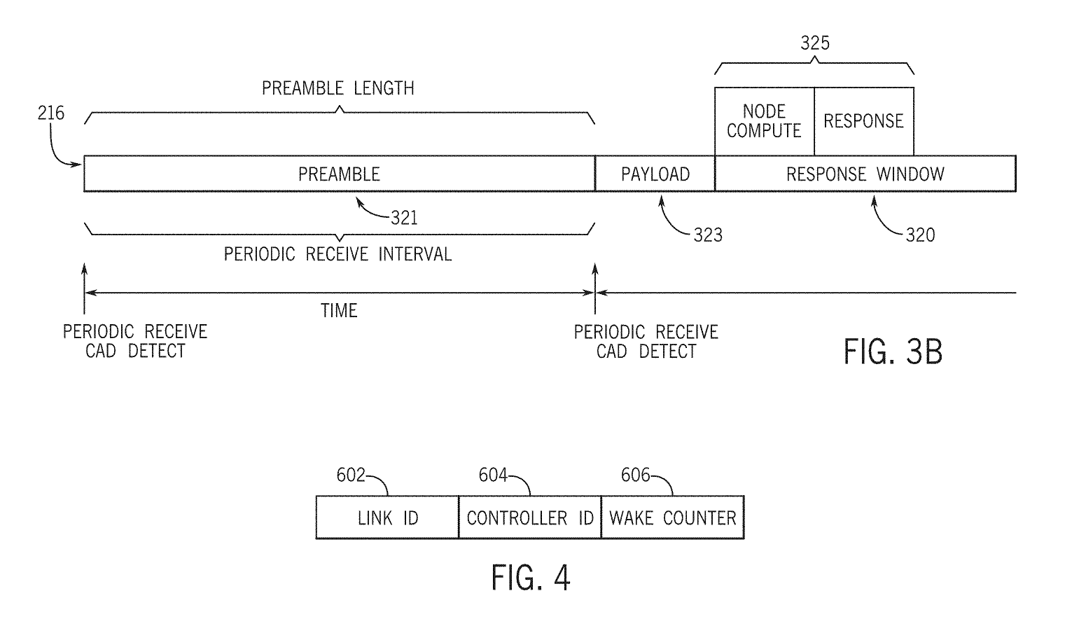

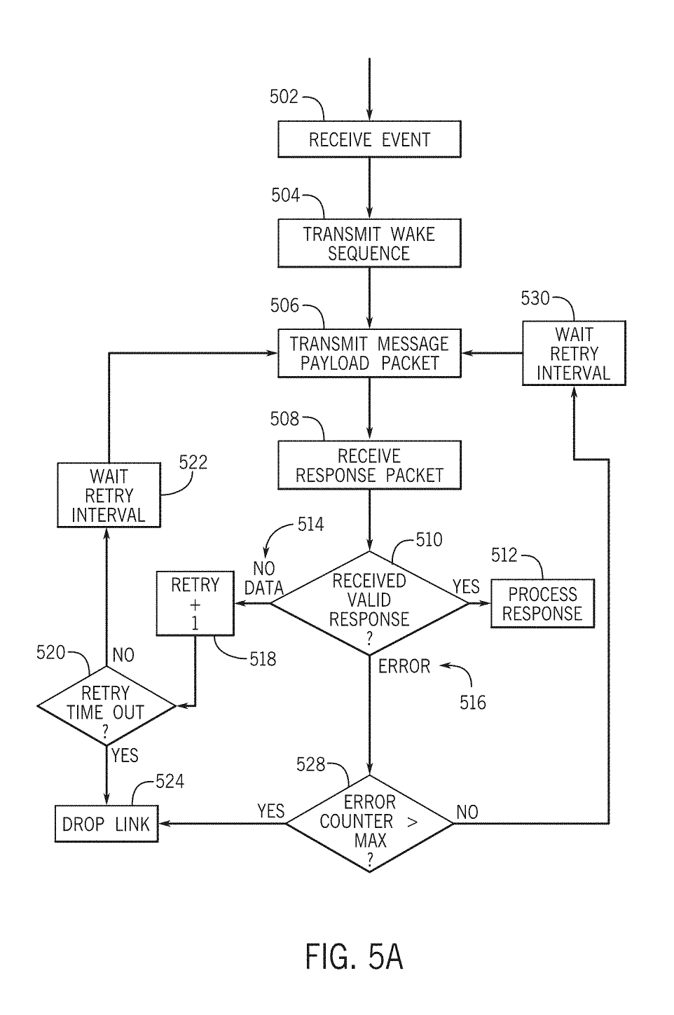

When the wait time interval ends, sensor device 204 may wake up to receive the message payload packet 218 from controller 202. An example of the message payload packet 218 is shown in FIG. 3B and will be discussed in more detail below. The message payload packet may include a request by the controller to the sensor or device to transmit data to the controller. The request by the controller may be in response to an event. For example, the controller may receive an event from an application indicating that a watering schedule is about to start. In response to that event, the controller may request sensor data from a precipitation sensor to determine whether there is sufficient precipitation so that the current watering schedule may be skipped. In response to the controller's request, sensor device 204 may transmit a response packet 220. The response packet may include the requested information, e.g., sensor data captured by the sensor device, which may be precipitation data. The message payload packet and response packet may include a suitable number of bits to hold respective data. The controller data request to the sensor may not be based solely on events, but could be reoccurring or other selected intervals that allow the controller to receive information from the sensor and other devices as the data accumulates. The timing between the controller and the sensor device is now further explained in detail with references to FIGS. 3A-4.

In FIG. 3A, a wake sequence may include multiple sequences of wake messages 302, 304, 306. For example, the wake message sequence may include two or more repeated wake messages (e.g., wake messages 308 in the first sequence 302; wake messages 310 in the second sequence 304; wake messages 316 in the third sequence 306). In other words, the wake sequence may actually include multiple wake messages, which define multiple options for the sensor to detect a wake message. Additionally, the wake messages within a sequence may be transmitted in sequence at a fix time interval, i.e., wake count interval 310. Two adjacent wake message sequences may be separated by an offset period 312, 314.

In some scenarios, the wake messages within a sequence may include a preamble 307 and a wake payload 309. The preamble may include data that can be detected by a sensor device and used to identify the energy transferred to the device, e.g., a known bit of data that the sensor can detect and understand to be transmitted from the controller. The wake payload may include additional data that can be used by the sensor device. For example, in FIG. 4, a wake payload in a wake message may include a Link ID 602, Controller ID 604, or a wake counter 606. In some instances, each of Link ID, Controller ID and wake counter may be of any suitable bit width.

In some scenarios, the preamble length may be selected to take a substantial portion of the CAD interval. For example, in each wake message, the preamble 307 is substantial relative to the length of the wake message 308, while the wake payload packet 309 is much shorter. For example, the preamble may larger by 20-80% of the payload packet. The longer length of the preamble defines sufficient time for the wake message to be received by the sensor device during the preamble. The intervals between each wake message will also allow a small “compute” time for the controller (e.g., CPU cycle and processing time for the message).

The number of wake messages per sequence may vary, for example, the number may be 20, in which case a long wake message sequence is broken into multiple wake messages at a wake count interval 310 with short preambles. By doing so, the sensor devices may still have a large receive interval (i.e. CAD interval) but needs only a short preamble (or a small window, i.e., the length of the wake message) to be “on” (out of a lower power state), after which the sensor device may sleep for the wait time interval before receiving the message payload packet. This results in battery saving for the sensor device. In some scenarios, the controller can guarantee that a preamble will be detected by the sensor device within two receive interval checks spaced between a CAD interval. In doing so, the length of each message sequence is no less than the CAD interval. Additionally, the controller may space the wakeup messages and compute a preamble length that will overlap at least once of the receive preamble checks on the sensor device.

Now, the wakeup sequence limits the timing requirements on the controller. In some scenarios, the time each wake message is transmitted is called total on-air time. The total on-air time may vary depending on the communication protocol. For example, given a spreading factor (SF), e.g., SF8 and 500 KHz bandwidth in a 902-928 MHz band; the payload time for transmitting 1-3 bytes is 4.096 ms; a CAD interval on a sensor device is two seconds; and the length of a preamble PREAMBLE_LEN=152 unites, e.g., milliseconds, the wakeup packet timing must use a preamble with an appropriate number of symbols that guarantees the following relationships:

WakeCountInterval=CAD Interval/Num Wake Packets Per Seq

PreambleTransmitTime+WakePayloadTransmitTime<Wake Count Interval

PreambleTransmitTime>Wake Count Interval/2

The actual preamble duration Tpreamble will be limited by the symbol width used. The time for this data to be sent can be used to determine the total on-air time TOnAir=Tpreamble+Tpayload. The actual time between packets may vary slightly due to processing/interface communication timing, and should be measured to ensure that it does not impact the final calculation of whether the preamble will be detected below.

In practice, the difference between the PreambleTransmitTime and the WakeCountInterval is to be minimized while allowing for compute time/timing fluctuation/errors between the two devices. The difference may be impacted by various activities in the system such as CPU tasks in the controller, which may also vary depend on the system. Minimizing the difference between PreambleTransmitTime and the WakeCountInterval increases the opportunity for the device to successfully wake up on CAD detect on one of the wake message sequences.

Now, the system leaves the receiver to calculate the appropriate receive window based on the received wakeup/preamble packet. With further reference to FIG. 3, once the sensor device receives a wake message 348, the sensor device may determine a wait time 342 and sleep for the period of the wait time before attempting to receive a message payload packet from the controller. For example, the sensor device may retrieve the wake counter (606 in FIG. 4) from the wake payload and use that counter to determine the wait time 342. In some instances, the wait time may be calculated as:

Wait≤(CAD Interval/Number of Wake Packets)*(Wake Count−1)

The sensor device will then wait for the message payload packet, then receive the message payload packet from the controller in a payload packet receive window 344. Additionally, the sensor device may wait for a timeout period Receive Payload Timeout sufficient to cover the additional dead time (PreambleTransmitTime plus WakePayloadTransmitTime). A margin, e.g., a percentage of the PreambleTransmitTime may be added to the timeout period. Alternatively, part of the Receive Payload Timeout can be added to the computed wait time 342 above to reduce the time that the radio is turned on for payload retrieval.

Additionally, and/or alternatively, the wake sequence may include additional wake message sequences, e.g., 304, 306. The first sequence of wake messages may be missed by the sensor device because each wake packet has a dead time where the preamble is not being transmitted (due to the transmission of wake payload or due to the turnaround time). Transmitting an additional wake message sequence will increase the chance that a wake message is received by the sensor device. After transmitting a wake message sequence, the controller may wait for an offset time before transmitting the second or third additional wake message sequence. To guarantee an overlap of at least one preamble, thus, a preamble will be detected, the offset 312, 314 between multiple wake message sequences need to meet the following:

Offset+PreambleTransmitTime>WakeCountInterval

Offset<PreambleTransmitTime

In the case of multiple wake message sequences, a sensor device may detect a wake message in any of the wake message sequences, e.g., the first sequence 302 or the second sequence 304. To differentiate between the multiple sequences, the wake counter may include information indicating which of the sequence the wake message being detected is in. For example, if a detected wake message in an initial sequence is detected, the sensor device may count down from n*Num Wake Packets Per Sequence, where n stands for the number of sequences. If a detected wake message is in the last sequence, the sensor device may count down from the number of wake packets per sequence.

With further reference to FIG. 3A, after transmitting one or more wake message sequences 302, 304, 306, the controller may transmit a message payload packet in a payload packet window 318, followed by receiving a response packet from the sensor device in a response window 320. Examples of the message payload packet 216 and the response packet 325 are shown in FIG. 3B. The sensor device may receive the message payload packet in a payload packet receive window 344, followed by transmitting a response payload packet to the controller in a response payload window 346. In response, the controller receives the response payload packet in the response window 320.

With reference to FIG. 3B, the message payload packet 216 may include a preamble 321 and a payload 321, where the preamble 321 includes a known sequence of data and the payload 321 is the additional information from the controller to be utilized by the sensor device. As shown, in this example, the preamble length may be selected to be just larger than a packet interval, e.g., 102-110 percent of the packet interval length and preferably around 105 percent of the packet interval length, such that it extends just past the CAD detect intervals. The payload 323 may include a request from the controller to the sensor device to transmit data. In this case, the sensor device will transmit its response packet 325 in the response window 320 following the message payload packet 216. The response packet 325 includes a timing length that includes a node compute time (e.g., for the sensor to ready its data), and the actual data response. The data response may include information detected or otherwise measured by the sensor.

In some scenarios, the sensor device may be attached to a fixed power source, e.g., an outlet or a permanent wire from a power line. The controller may determine that the sensor device is powered by a fixed power source and the communication between the controller and the sensor device may be streamlined. In some scenarios, the number of wake message in a sequence can be one, with the preamble time greater than the CAD interval of the sensor device. Further, the controller may be configured to transmit the message payload packet immediately after transmitting a single wake message. Correspondingly, the sensor device may receive the messaging payload packet immediately after detecting the wake message.

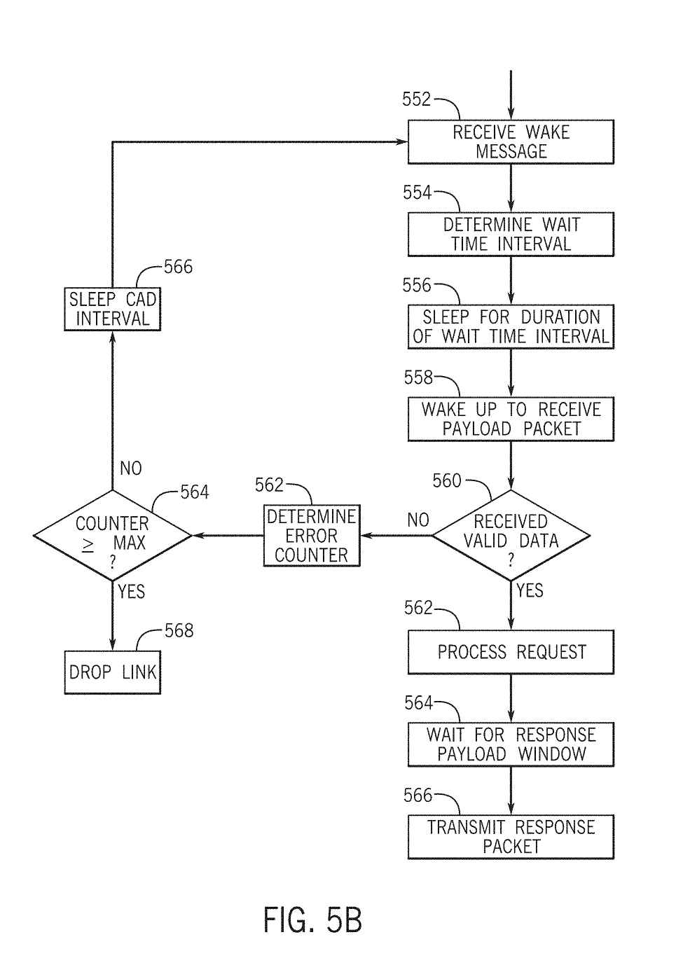

Various methods can be implemented in above described system. In FIG. 5A, a method that can be implemented in a controller may include receiving an event 502 from an application, where the event may require retrieving information, such as precipitation data, from a sensor device. The method may also include transmitting a wake sequence 504 to the sensor device, transmitting a message payload packet 506, and receiving a response packet from the sensor 508, where each step was described with reference to FIG. 3A. To avoid a deadlock, the method may also include determining whether a received response packet is valid 510. If the received response packet is valid, the method may proceed to processing the response 512. If the received response packet is invalid because no data were received 514, in which case the method will increment a retry counter 518. The retry counter can be initially set to zero. If the retry counter is less than a time out threshold 520, the method will wait for a retry interval 522, then transmit the message payload packet 506 again.

Additionally, and/or alternatively, if the received response is invalid because the data received has errors 516, the method may determine an error counter, and check whether the error counter exceeds a maximum threshold 528. The error counter may depend on the type of error detection scheme being used. For example, the error scheme may be an error correcting code (ECC) such as a cyclic redundancy check (CRC), for which the error code may be the number of bit failures. The error code may also be an encryption tag, ECPT. Other error detection scheme may also be used. If the error counter exceeds a maximum threshold, the method may determine that the communication link between the controller and the sensor device is not reliable. The method may drop the link 524 between the controller and the sensor device. If the error counter does not exceed the maximum threshold, the method may include waiting for a retry interval 530, then transmit the message payload packet 506 again.

The retry interval in blocks 522, 530 may be predefined. In order to avoid interference, the method may further apply randomization to the retry interval 522, 530 before attempting further communication to the device. This retry interval will represent an exponential backoff to avoid two controllers on the same transmit time interval.

In FIG. 5B, a method that can be implemented in a sensor device that is in communication with a controller may include: receiving a wake message from the controller 552; determining a wait time interval 554; sleeping for a duration of the wait time interval 556; and waking up to receive a message payload packet from the controller 558 in a payload packet receive window, each of the steps was described with reference to FIG. 3A. The method may further determine whether valid data was received from the controller 560. If the method determines that valid data was received, the method may process the request in the message payload packet 562, wait for the response payload window 564 (346 in FIG. 3A) and transmit a response packet 566 to the controller in the response payload window.

Additionally, and/or alternatively, if no valid data was received from the controller, the method may determine an error counter 562 and check whether the error counter exceeds a maximum threshold 564. For example, the error counter may be a retry counter, which can be initially set to zero and increment each time an error occurs. The error counter may alternatively, or additionally, be determined based on an error code associated with an error detection scheme. As above described with reference to FIG. 5A, CRC or ECPT flag can be used. If the error counter exceeds a maximum threshold, the method may determine that the communication link between the controller and the sensor device is not reliable. The method may drop the link 568 between the controller and the sensor device. If the error counter does not exceed the maximum threshold, the method may include sleeping according to the CAD interval 566 and waiting to receive a wake message 552 from the controller again.

In other embodiments, the above described methods can be extended to any suitable communications between a controller and a node device, where the node device may be operated on a battery. In some scenarios, a method for communication between a controller and a node device may include, by a controller: transmitting a first plurality of wake messages in sequence to at least one node device in the communication system; subsequent to transmitting the plurality of wake messages in sequence, transmitting a message payload packet to the device; and receiving a response packet from the node device responsive to the message payload packet. The method may further include, by the node device: receiving one of the first plurality of wake messages from the controller; determining a wait time interval; sleeping for a duration of the wait time interval; waking up to receive a message payload packet from the controller; and transmitting a response packet to the controller responsive to the message payload packet.

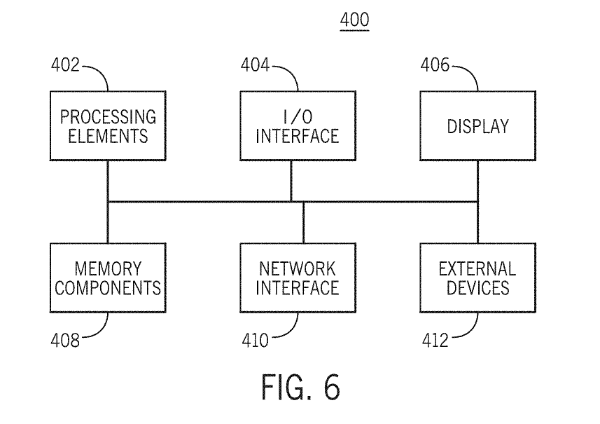

FIG. 6 shows a simplified block structure for a computing device that may be used with the system 100 or integrated into one or more components of the system. For example, the server 104, the controller 102, 112, and/or one or more sensors 120a-120c or nodes may include one or more of the components shown in FIG. 7 and be used to execute one or more of the operations disclosed in FIGS. 2-4, 5A and 5B. In FIG. 6, the computing device 400 may include one or more processing elements 402, an input/output interface 404, a display 406, one or more memory components 408, a network interface 410, and one or more external devices 412. Each of the various components may be in communication with one another through one or more busses, wireless means, or the like.

The processing element 402 may be any type of electronic device capable of processing, receiving, and/or transmitting instructions. For example, the processing element 402 may be a central processing unit, microprocessor, processor, or microcontroller. Additionally, it should be noted that some components of the computer 400 may be controlled by a first processor and other components may be controlled by a second processor, where the first and second processors may or may not be in communication with each other.

The memory components 408 are used by the computer 400 to store instructions for the processing element 402, as well as store data, such as the fluid device data, historical data, and the like. The memory components 408 may be, for example, magneto-optical storage, read-only memory, random access memory, erasable programmable memory, flash memory, or a combination of one or more types of memory components.

The display 406 provides visual feedback to a user and, optionally, can act as an input element to enable a user to control, manipulate, and calibrate various components of the computing device 400. The display 406 may be a liquid crystal display, plasma display, organic light-emitting diode display, and/or cathode ray tube display. In embodiments where the display 406 is used as an input, the display may include one or more touch or input sensors, such as capacitive touch sensors, resistive grid, or the like.

The I/O interface 404 allows a user to enter data into the computer 400, as well as provides an input/output for the computer 400 to communicate with other devices (e.g., flow controller 104, flow detector 102, other computers, speakers, etc.). The I/O interface 404 can include one or more input buttons, touch pads, and so on.

The network interface 410 provides communication to and from the computer 400 to other devices. For example, the network interface 410 allows the server 110 to communicate with the flow controller 104 and the flow detector 102 through the network 114. The network interface 410 includes one or more communication protocols, such as, but not limited to WiFi, Ethernet, Bluetooth, and so on. The network interface 410 may also include one or more hardwired components, such as a Universal Serial Bus (USB) cable, or the like. The configuration of the network interface 410 depends on the types of communication desired and may be modified to communicate via WiFi, Bluetooth, and so on. In many embodiments, the network interface includes a transmitter and a receiver that transmit and receive radio or other electrical data communications, e.g., energy on radio frequencies.

The external devices 412 are one or more devices that can be used to provide various inputs to the computing device 400, e.g., mouse, microphone, keyboard, trackpad, or the like. The external devices 412 may be local or remote and may vary as desired.

The foregoing description has broad application. For example, while examples disclosed herein may focus on irrigation systems, it should be appreciated that the concepts disclosed herein may equally apply to other control systems, such as lighting control, home appliances control, smart home control, and/or control of Internet-of-Things (IoT) devices. Similarly, communication messaging in FIGS. 2-4 are described with examples in communications between controller and sensor devices in irrigation system, the system and methods may also be used with any other type of communications between devices. Accordingly, the disclosure is meant only to provide examples of various systems and methods and is not intended to suggest that the scope of the disclosure, including the claims, is limited to these examples.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The drawings are for purposes of illustration only and the dimensions, positions, order and relative sizes reflected in the drawings attached hereto may vary.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

From the foregoing it will be appreciated that, although specific embodiments of the present disclosure have been described herein for purposes of illustration, various modifications may be made without deviating from the spirit and scope of the present disclosure. The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An irrigation system comprising:
a sensor device configured to detect irrigation characteristics indicating one or more irrigation conditions; and
a controller in electrical communication with the sensor device and with one or more irrigation valves to activate the irrigation valves according to an irrigation schedule, wherein the controller:
transmits a first plurality of wake messages in sequence to the sensor device; and
subsequent to transmitting the plurality of wake messages in sequence, transmits a message payload packet to the sensor device;
wherein the sensor device sleeps for a duration of a wait time interval after receiving one of the plurality of wake messages in the wakeup sequence and before receiving the messaging payload packet.

2. The irrigation system of claim 1, wherein the controller transmits each of the first plurality of wake messages in sequence at a wake count interval.

3. The irrigation system of claim 1, wherein:
the sensor device periodically checks for wake messages at a channel activity detection interval; and
the controller transmits the first plurality of wake messages in a time period that is no less than the channel activity detection interval.

4. The irrigation system of claim 1, wherein the controller also receives a response packet from the sensor device responsive to the message payload packet.

5. The irrigation system of claim 1, wherein the controller transmits a second plurality of wake messages in sequence after transmitting the first plurality of wake messages and before transmitting the message payload packet.

6. The irrigation system of claim 5, wherein the controller waits for an offset time after transmitting the first plurality of wake messages in sequence and before transmitting the second plurality of wake message in sequence.

7. The irrigation system of claim 1, wherein the controller further:
pairs with the sensor device;
determines a communication channel over a communication network; and
establishes a communication link with the sensor device on the communication channel.

8. The irrigation system of claim 7, wherein the communication channel for the sensor device has a unique radio frequency relative to other devices in communication with the controller.

9. The irrigation system of claim 7, wherein the controller communicates with a server device on the communication network to determine the communication channel for the sensor device.

10. The irrigation system of claim 7, wherein the controller monitors one or more communication channels on the communication network to determine the communication channel for the sensor device.

11. The irrigation system of claim 1, wherein:
the plurality of wake messages comprise a wake counter; and
the sensor device is configured to determine the wait time interval based on the wake counter in the one wake message received.

12. The irrigation system of claim 1, wherein the sensor device is a soil moisture sensor, a flow sensor, or a precipitation sensor.

13. A sensor device for use in a sprinkler system comprising:
a network interface in electrical communication with a controller;
a sensor configured to capture sensor data; and
a processing element in electrical communication with the sensor and the network interface, wherein the processing element:
receives one of a plurality of wake messages from the controller, wherein the plurality of wake messages are transmitted in sequence;
determines a wait time interval;
sleeps for a duration of the wait time interval; and
wakes up to receive a message payload packet from the controller.

14. The sensor device of claim 13, wherein the processing element further transmits a response packet to the controller responsive to the message payload packet, the response packet comprising the sensor data.

15. The sensor device of claim 13, wherein:
each of the plurality of wake messages comprises a wake counter; and
the processing element further determines the wait time interval based on the wake counter in the wake message that was received.

16. The sensor device of claim 13, wherein the processing element further receives a wake message from the controller at each of a channel activity detect (CAD) interval.

17. The sensor device of claim 13, wherein the controller is an irrigation system controller and the sensor is one of a soil sensor, a flow sensor, or a precipitation sensor.

18. The sensor device of claim 14, wherein the response packet comprises sensor data indicating one or more irrigation conditions.

19. A method for transmitting data within a sprinkler system, the method comprising:
by a sprinkler controller:
transmitting a plurality of wake messages in sequence to at least one node device in the communication system;
subsequent to transmitting the plurality of wake messages in sequence, transmitting a message payload packet to the node device; and
receiving a response packet from the node device responsive to the message payload packet;
by the node device:
receiving one of the plurality of wake messages from the sprinkler controller;
determining a wait time interval;
sleeping for a duration of the wait time interval;
waking up to receive a message payload packet from the sprinkler controller; and
transmitting a response packet to the controller responsive to the message payload packet.

20. The method of claim 19, wherein:
each of the plurality of wake messages comprises a wake counter; and
determining the wait time interval is based on the wake counter in the wake message that was received.
